(19) United States
(12) Patent Application Publication
(10) Pub. No.: US 2012/0048102 A1
(43) Pub. Date: Mar. 1, 2012

(54) WINDOW ASSEMBLY

(75) Inventors: Roy Nahmias, Merom Hagalil (IL); Leor Tikotzenski, Kibbutz Kfar Hanasi (IL)

(73) Assignee: PLASAN SASA LTD., M.P. Marom Hagalil (IL)

(21) Appl. No.: 13/191,274

(22) Filed: Jul. 26, 2011

(30) Foreign Application Priority Data
Jul. 26, 2010 (IL) 207242

(51) Int. Cl. F41H 5/26; E06B 3/34; E05F 15/04; F41H 7/02

(52) U.S. Cl. 89/36.08; 49/358

(57) ABSTRACT

An armored assembly comprises a wall having inner and outer surfaces, and an opening extending therebetween. The opening has a rim area surrounding the opening. The assembly comprises a window having a frame sized/shaped to externally cover the opening and rim area, and a pane fitted within the frame. The window is displaceably attached to the outer surface of the wall. The assembly comprises a drive mechanism including a motor spaced from the outer surface of the wall by its inner surface, and a drive member operably connected to the motor. The drive member is at least partially protruding from the outer surface of the wall in the direction away from its inner surface. The assembly has a driven member attached to the window, which is disposed between the frame and wall. The driven member is configured for engagement with the drive member to displace the window.

### CROSS-REFERENCE TO RELATED APPLICATIONS

This application claims priority to Israel Patent Application No. 207242 filed on 26 Jul. 2010, the contents of which are incorporated herein, in their entirety, by this reference.

### TECHNICAL FIELD

Embodiments of the invention relate to windows of armored vehicles, in particular, windows adapted to displace in order to allow a passenger of the armored vehicle access to the outside environment.

### BACKGROUND

In armored structures/installations/vehicles, it is common to provide openings/windows through which the exterior of the structure/installation/vehicle may be viewed and/or accessed from the interior of the structure/installation/vehicle.

In most cases, such openings/windows are also armored, providing protection against incoming threats such as projectiles. Some such windows are designed as fixed windows, i.e. they are affixed to the structure/installation/vehicle without the ability to open them and allow access from interior to exterior. Other windows are designed with the ability to open/close so as to allow access as noted above.

In some of these structure/installation/vehicle, it may be desired to open the window to a very narrow extent, so as to allow extending a barrel of a firearm therethrough or exchanging papers/documents, without completely exposing the opening which the window covers.

It should be understood that windows of a structure are usually configured for allowing a person located within the interior of the structure to properly view the exterior through the window. As such, the window is usually located at the height of the person's head, when the person is properly situated within the structure (e.g. sitting in a vehicle, standing at a guard post etc.).

As a result, when the person is properly situated within the structure as suggested above, a topmost portion of the window is usually located above the person's direct line of vision, and sometimes even above his head.

There are known several arrangements for pivotally manipulating a window (usually a vehicle window), for example, those arrangements disclosed in DE202004015589U1, FR2583003, U.S. Pat. No. 4,104,827 and US2006265958.

### SUMMARY

According to the subject matter of the present application, there is provided an assembly constituting a part of a structure having an interior, comprising:
a wall having an inner surface and an outer surface;
   the wall being formed with an opening extending between the inner surface and the outer surface;
   the opening having a rim area surrounding the opening;
a window comprising:
   a frame sized and shaped so as to externally cover the opening and the rim area;
   a window pane fitted within the frame;
   the window being attached to the outer surface of the wall in a displaceable manner;
a drive mechanism comprising:
   a motor; and
   a drive member connected to the motor and configured to be operated thereby;
   the drive member at least partially protruding from the outer surface of the wall in the direction away from its inner surface; and
   the motor being located so as to be spaced from the outer surface of the wall by its inner surface; and
a driven member attached to the window directly or indirectly;
   the driven member being disposed between the frame and the wall;
the driven member being configured for engagement with the drive member so as to displace the window and thereby expose the exterior of the structure to its interior via at least a portion of the opening.

The structure can be of the kind whose interior is to be protected from an incoming ballistic threat, in which case the wall can be an armored wall and/or the window can be an armored window. In this connection, the terms ‘outer surface’ and ‘inner surface’ respectively, should be understood with respect to the interior to be protected, i.e. the interior located behind the inner surface is protected by the armored wall from threats incoming towards the outer surface.

It is noted that the entire window can be an external window located, in its entirety, at the exterior of the structure. The arrangement can be such that both in the first, closed position and in the second, open position, the majority of the window is located outside the outer surface of the wall.

It should be appreciated that such an arrangement allows fitting, to the wall of the structure, armored windows of different thicknesses (depending on their purpose and the projectile there are configured to protect the structure from), the thickness of the window not being affected by the thickness of the door.

The armored window is displaceable, by virtue of the driving mechanism and driven member, between a first, fully closed position in which the frame of the armored window fully covers the opening and the rim area, and at least one additional position, which is a second, open position, in which the armored window is offset with respect to the opening, such that at least a portion of the opening is not covered by the armored window, allowing exposure of the environment to the interior of the structure to be protected.

More particularly, the armored window can be displaceable between the above first, fully closed position and an open, end position in which the armored window is at its maximal offset with respect to the opening, i.e. allowing a maximal portion of the opening to be used in exposing the exterior of the structure to its interior.

The rim area of the opening can be defined as having a top portion and a bottom portion, the terms top and bottom referring to a vertical direction when the structure is properly positioned on a leveled surface. For example, if the structure is a vehicle, the top portion may be the portion closer to a roof of the vehicle while the bottom portion can be the portion closer to the wheelbase of the vehicle.

According to a particular example, the arrangement can be such that the window is configured, when in the second, open position, to expose a portion of the opening which is closer to the bottom portion of the rim area. Such an arrangement can be achieved, for example, by the window displacing in a generally upward direction.

It is understood that such a configuration can allow a person located within the structure with a more comfortable access for performing barrel extraction/document passage through the opening, compared to an arrangement in which the exposed portion of the opening is closer to the top portion of the rim area.

In general, the window can be configured such that when the window is in the second, open position, the exposed portion of the opening is located at about the shoulder height of a person located within the structure and properly situated therein. More specifically, the arrangement can be such that when the window is in the second, open position, the person is still able to maintain a direct line of vision to the exterior through the window, while at the same time having comfortable access to barrel extraction/document passage through the opening.

According to one example, displacement of the armored window can be a linear movement along the armored wall. In this case, the window frame can be articulated to rails on the armored wall, so as to displace within and along these rails during the operation of the drive member.

According to another example, the displacement of the armored window can be a rotary movement, i.e. pivoting about an axis. In this case, the frame of the window can be articulated to the armored wall via a pivot hinge, so as to be displaceable thereabout under operation of the motor.

According to the latter example, the armored window can further comprise a pivot member fixedly attached to the pivot hinge, and configured for fixed attachment (e.g. bolting, welding) to the frame of the armored window. The arrangement can be such that the pivot member is configured to revolve about the axis of the pivot hinge together with the armored window.

In accordance with the above example, the driven member can be attached and/or integrated with the window at a location thereof which is remote from the pivot hinge and from the axis, so as to reduce the power required for pivoting the window about the axis. In particular, the pivot hinge and the driven member can be located at opposite ends of the window.

The armored window can be designed such that the mechanical engagement between the driven member and the driving motor is selective, so that the window may assume a first, engaged position in which the driven member is engaged with the driving motor and is configured to be driven thereby and a second, disengaged position in which the driven member is disengaged from the driving motor. Selection between the engaged and disengaged position can be performed by a person located within the structure.

It is appreciated that in the second, disengaged position, the window can be configured to freely displace with respect to the opening of the structure. One of the advantages of such an arrangement lies in emergency conditions in which it is required for the personnel to exit the structure. If the driving motor, driven member or any other element of the window taking part in its displacement malfunctions, selectively changing the window's position to the second, disengaged position, can allow the personnel within the structure to open the window and exit the structure therethrough.

The armored assembly can further comprise a load bearing device configured for providing to the armored window with a force equivalent to its weight, thereby effectively cancelling the weight so that the motor of the drive mechanism is not required to support the weight of the window. In other words, under operation of the load bearing device, the armored window is at a mechanical equilibrium, so that the driving mechanism can operate at a very low power consumption.

According to the first of the above examples (linear movement), in case the window is adapted to displace along rails, the load bearing device can be configured for directly providing a load equivalent and opposite in direction to that of the weight of the window. According to the second of the above examples, the load bearing device can be configured for providing a moment (torque) about the pivot hinge which is equivalent and opposite in direction to the torque applied to the hinge by the weight of the window.

According to a specific example, the load bearing device can be a hydraulic/pneumatic piston.

In addition, regardless which of the above examples is used, the armored wall can be formed with at least one main protective rail within which a portion of the window is configured to be received, so that the window can displace therealong. In particular, the main protective rail/s can fulfill at least the following functions: providing ballistic protection to the portion of the window received therein, and, securing the window to the armored wall so as to minimize displacement thereof in a direction perpendicular to the inner/outer surface of the armored wall.

The main protective rail/s can be sized and shaped according to the designed trajectory of displacement of the window. In particular, in case the window is designed for linear movement, the rail/s can be straight and extend along at least one side of the armored window. In case the window is designed for rotational movement (i.e. via a pivot hinge), the rail/s can be formed along a side of the window opposite the pivot hinge.

The arrangement can be such that throughout the displacement of the armored window, regardless of its position (open/closed), a portion of the armored window is always received within the protective rail/s.

The armored wall can also comprise at least one auxiliary protective rail configured for receiving another portion of the armored window in either or both of the first, fully closed position or the open, end position. In particular, the armored wall can comprise a first auxiliary protective rail configured for receiving a first portion of the window, when the latter is in its first, fully closed position, and a second auxiliary protective rail configured for receiving therein a second portion of the window, when the latter is in its open, end position.

The auxiliary protective rail/s can be adapted to fulfill the same function as that fulfilled by the main protective rail/s.

According to an alternative/complimentary design, the armored window can be formed with an armored rail and the armored wall can be formed with an elongated plank, such that at least in the first, fully closed position, the elongated plank is received within the armored rail of the window. Under this design, the use of an auxiliary protective rail for the open, end position can be eliminated.

With respect to the above examples, the main protective rail/s, auxiliary protective rail/s and the elongated plank can all be made of ballistic materials, configured for providing ballistic protection against incoming threats. Examples of such materials can be steel, steel alloys, iron etc.

The armored window having any of the above features can further comprise a protective plate disposed between the window frame and the driven member, and configured for providing at least the driven member with ballistic protection. In particular, the protective plate can be sized and shaped so as to protect both the driven member and the drive member (and in general, all components of the driving mechanism located on the outer surface of the armored wall). The protective plate can be made of a ballistic material, e.g. steel, steel alloys, iron etc.

According to a specific design, the arrangement can be such that the protective plate constitutes that portion of the armored window which is received within the main protective rail/s.

With respect to all of the above, one of the main advantages of the subject matter of the present application is that the drive motor can be completely protected by the armored wall, and only a small portion of the driving mechanism (the drive member) is ‘sticking out’ of the armored wall. However, under the above design, even the drive member can be protected by the armored window, thereby forming a structure under which all components responsible for displacement of the window are ballistically protected.

The armored assembly can be used to provide a person located behind the armored wall with access to the outside environment (i.e. in front of the armored wall), by displacing the window so as to expose a small portion of the opening, usually covered by the window. This may be used, for example, for extending to the outside a barrel of a weapon in order to fire at a target or for exchanging papers.

It should be understood that the above design of the armored assembly allows performing the above operations (firing, exchanging papers) while providing maximal protection to a person located behind the armored wall.

The armored wall can be part of a structure, e.g. a wall or a door of an immobile structure. Alternatively, the armored wall can constitute part of a vehicle hull, in particular, a door of the vehicle.

### BRIEF DESCRIPTION OF THE DRAWINGS

In order to understand the invention and to see how it may be carried out in practice, embodiments will now be described, by way of non-limiting example only, with reference to the accompanying drawings, in which: FIGS. 1A to 1D are schematic respective left isometric, front, rear and right isometric views of an armored assembly according to the subject matter of the present application;

FIG. 2A is a schematic rear isometric view of the assembly shown in FIGS. 1A to 1D, with some of the components thereof removed;

FIG. 2B is a schematic enlarged view of detail A shown in FIG. 2A;

FIG. 2C is a schematic top view of the assembly shown in FIG. 2A;

FIG. 3A is a schematic left isometric view of a portion of the assembly shown in FIG. 1A, with components thereof removed;

FIG. 3B is a schematic enlarged view of detail C shown in FIG. 3A;

FIG. 4 is a schematic rear isometric view of a portion of the assembly shown in

FIGS. 1A to 1D;

FIG. 5A is a schematic left isometric view of a portion of the assembly shown in FIGS. 1A to 1D, with some of the components thereof removed;

FIG. 5B is a schematic enlarged view of detail B shown in FIG. 5A;

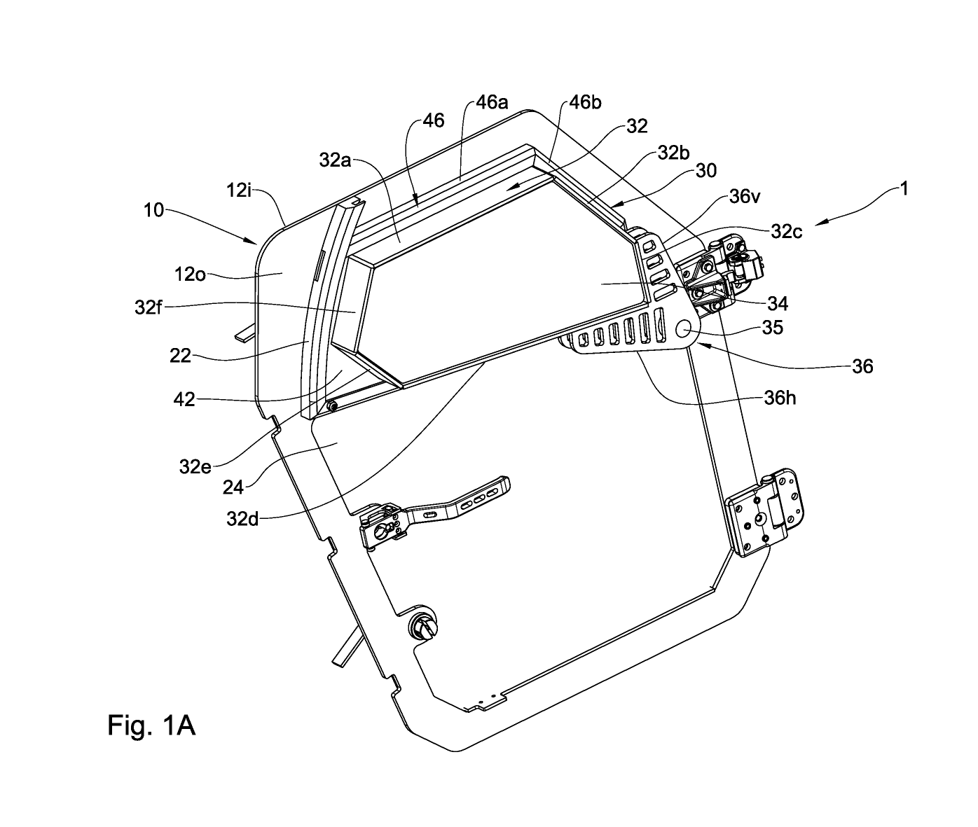

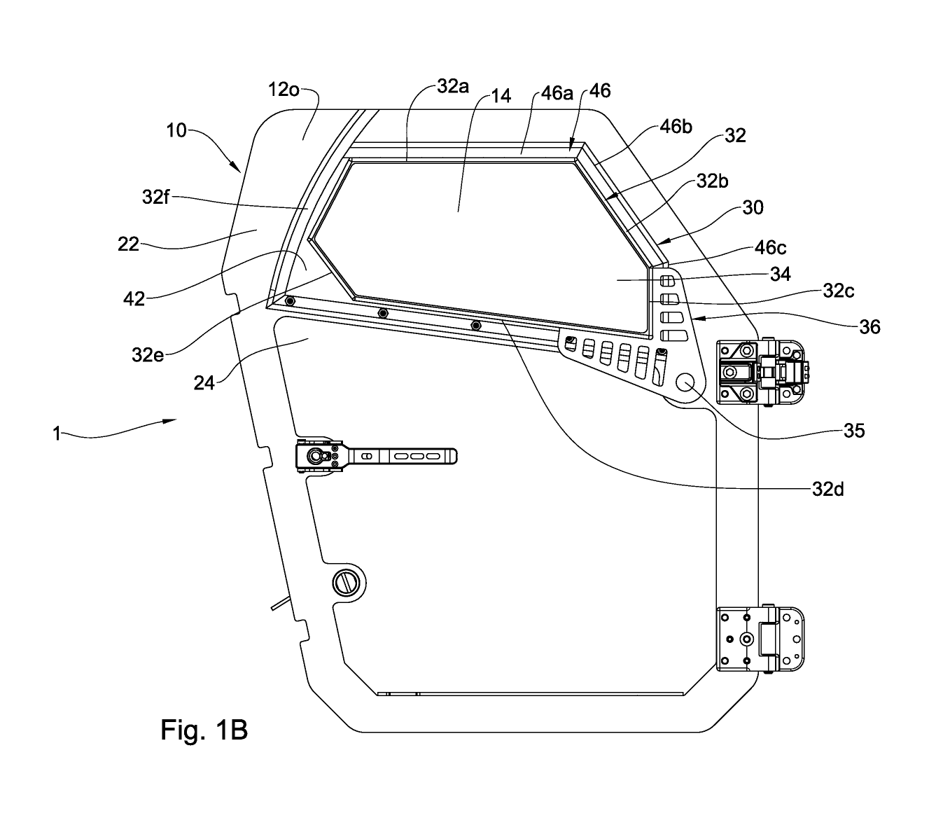

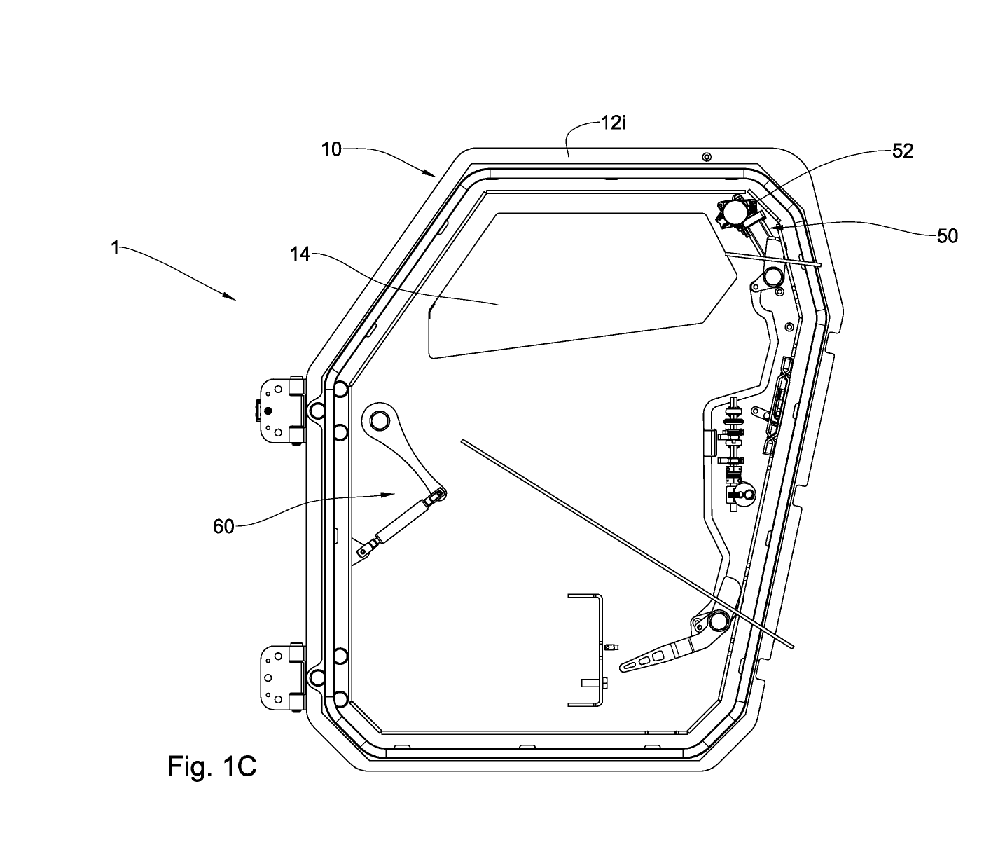

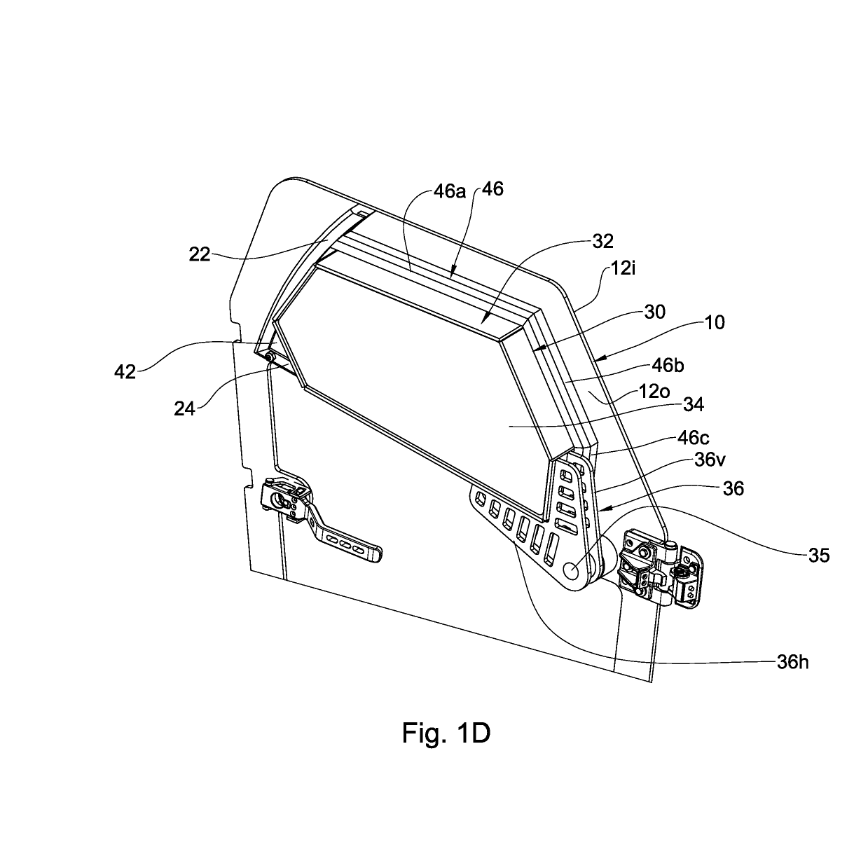

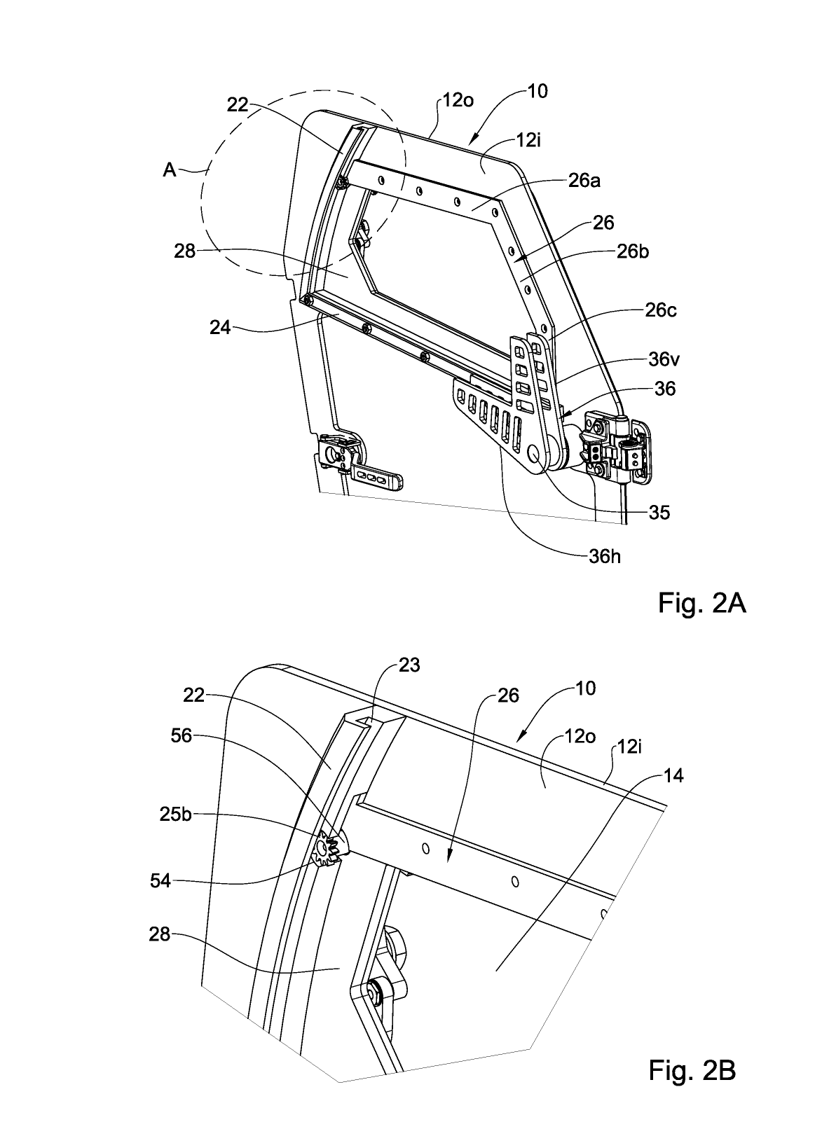

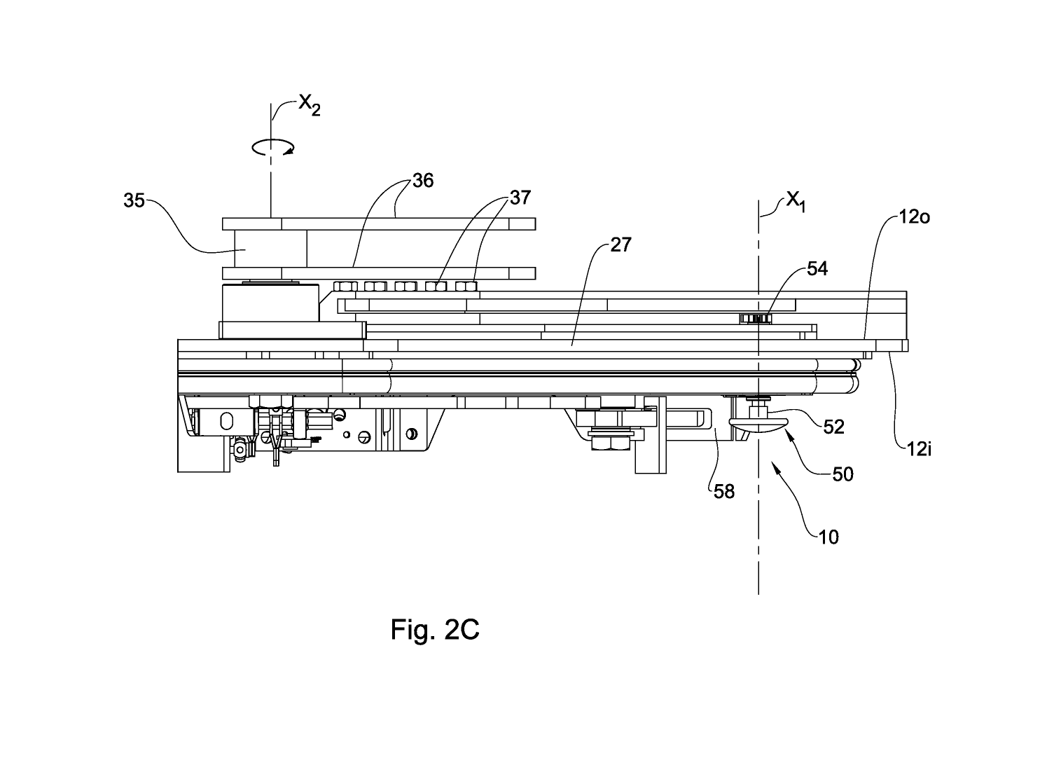

FIG. 6 is a schematic left isometric view of the assembly shown in FIG. 2A, with further components thereof being removed;

FIGS. 7A to 7D are schematic respective left isometric, front, rear and rear isometric views of an armored assembly according to the subject matter of the present application;

FIGS. 8A and 8B are schematic perspective cross-section views showing the decoupling mechanism, which when pulled, decouples the gear from the window (i.e. the teeth); and

FIG. 9 is a partial side view of the decoupling mechanism shown in FIGS. 8A and 8B.

### DETAILED DESCRIPTION OF EMBODIMENTS

With reference to FIGS. 1A to 1D, there is shown a vehicle door assembly generally designated as 1, comprising a vehicle door 10 and a window assembly 30 mounted onto the door 10.

The vehicle door 10 comprises a body 12 having an external surface 12i and an internal surface 12o, and being formed therein with an opening 14, extending between the inner surface 12i and the outer surface 12o.

The vehicle door 10 has mounted thereon a first protective arrangement 20 and the window assembly 30 is fitted thereon with a second protective arrangement 40. In addition, the door 10 further comprises a driving mechanism 50 and a counter-weight mechanism 60, fitted to the inner surface 12i of the body 12.

It is observed that the opening 14 is of an irregular polygonal shape, and that the window assembly 30 is correspondingly sized and shaped to effectively cover the opening 14 when externally mounted thereto.

The window assembly 30 comprises a window frame 32 comprising a plurality of slats 32a to 32f, consecutively attached to one another to form the irregular shape of the opening 14. The window frame 32 accommodates therein a window pane 34, made of an opaque armored material, in this case, layered glass.

The window frame 32 is attached to two pivoting units 36, each having a vertical arm 36v and a horizontal arm 36h transverse to the vertical arm 36v, the arrangement being such that the vertical arm 36v and horizontal arm 36h are fixedly attached to the slats 32c and 32d of the window frame 32 respectively, thus bearing the weight of the window pane 34.

The pivoting units 36 are also fixedly attached to a pivot hinge 35, configured for rotating about an axis X oriented in a direction transverse to the inner/outer surface 12i, 12o of the body 12 of the door 10. The arrangement is such that the window assembly 30 is configured for rotating about the axis X together with the pivoting units 36.

It is observed that the entire window assembly 30 is externally mounted onto the 30 vehicle door 10, and is not received therein. It is appreciated that one of the advantages of such a design is that the thickness of the window pane (in a direction transverse to the surfaces 12i, 12o, is not limited by the thickness of the door 10 (as opposed to arrangements in which the window is configured to be received within the door when exposing the opening). Thus, the thickness window pane 34 can be almost freely chosen according to the desired protection level of the vehicle.

With additional reference being drawn to FIGS. 2A and 2B, the driving mechanism 50 is shown, comprising a driving motor 58, a decoupling mechanism 52 and a gear 54 articulated to the motor and configured to be driven thereby using a shaft 56 (FIG. 2B). It is observed that while the gear 54 protrudes from the outer surface 12o of the door (i.e. to the exterior of the door), the motor 58 (shown FIG. 1C) of the driving mechanism 50 is located behind the door 10, and is shielded thereby from incoming threats.

It is also noted that the axis of the shaft 56 is parallel to the axis X of the pivot hinge 35, the design being such that the driving mechanism 50 is configured for powering the window assembly 30 about the pivot axis 35.

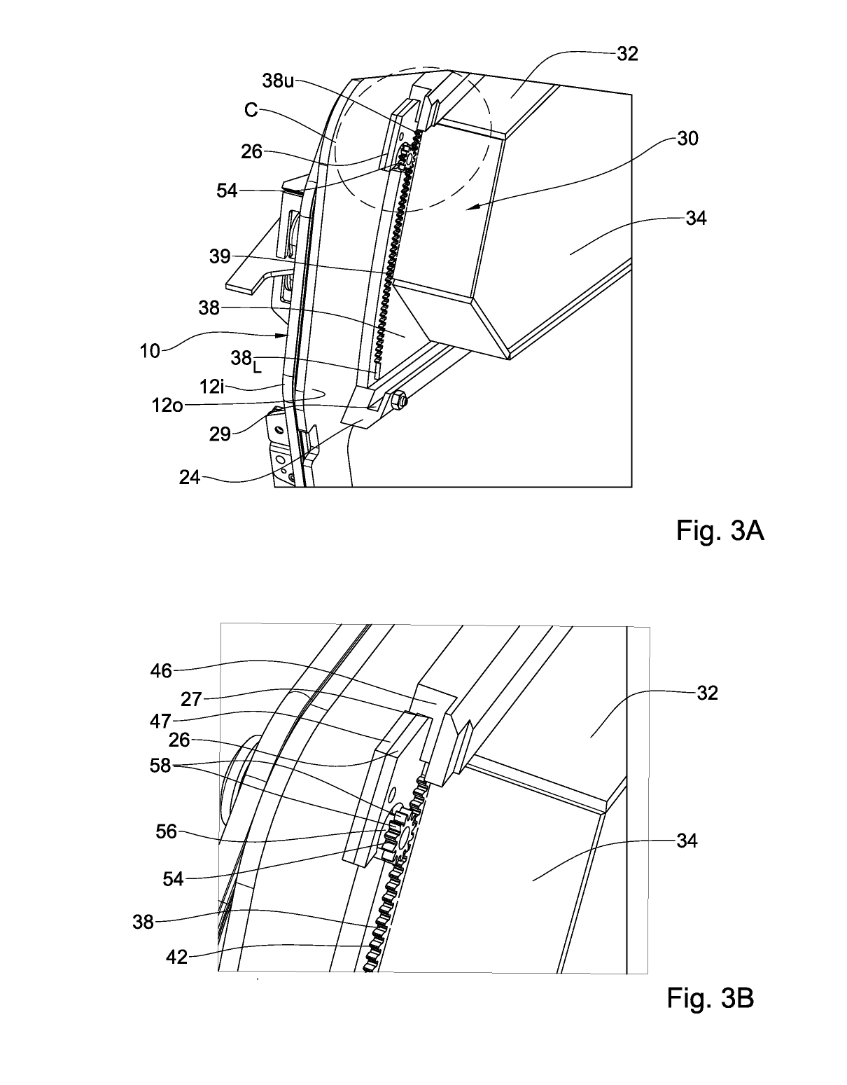

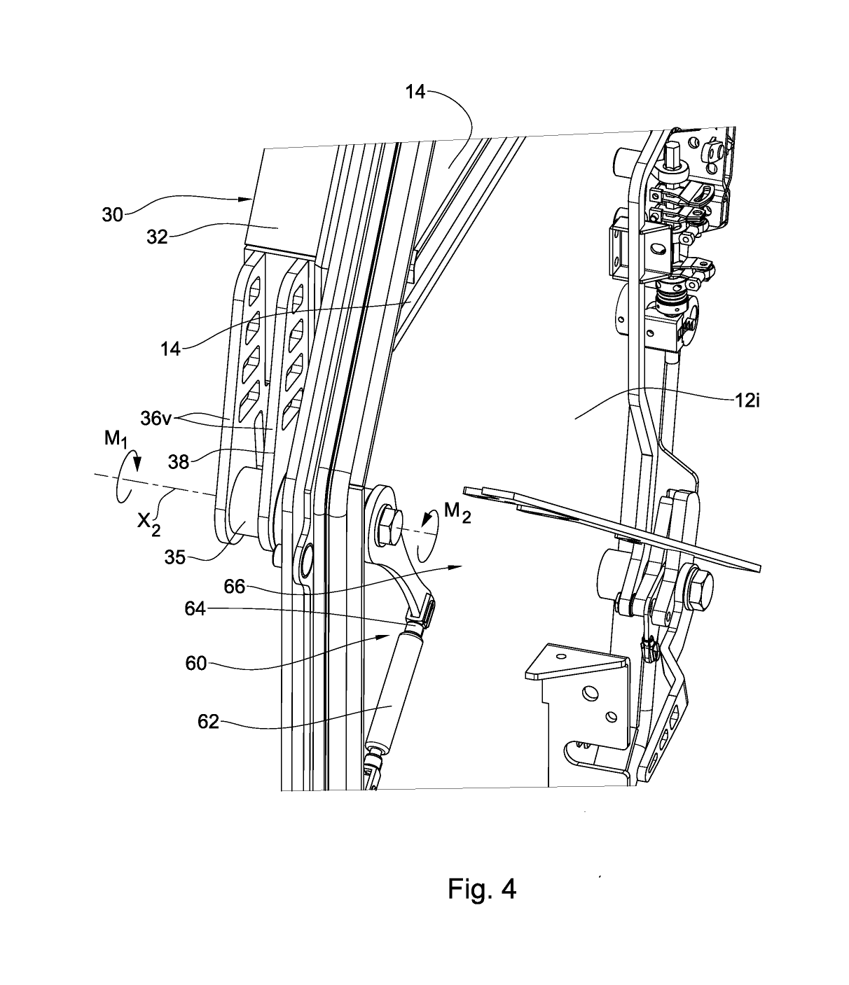

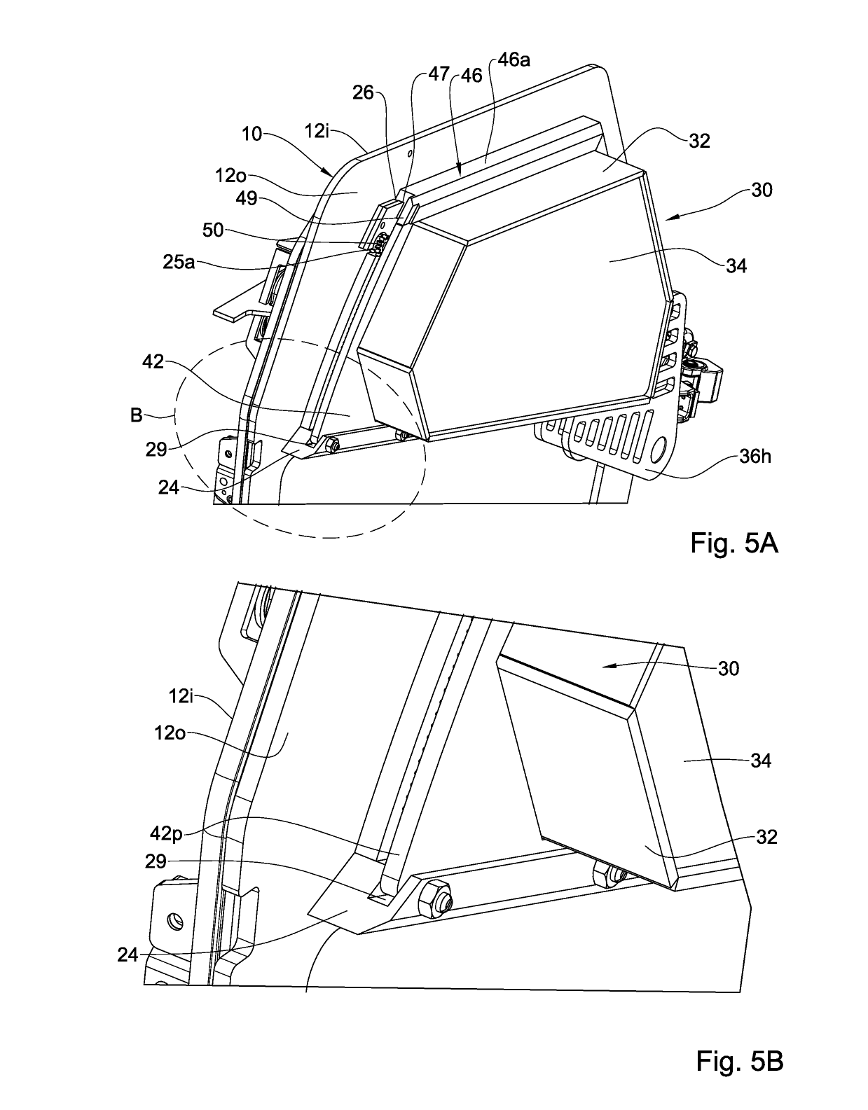

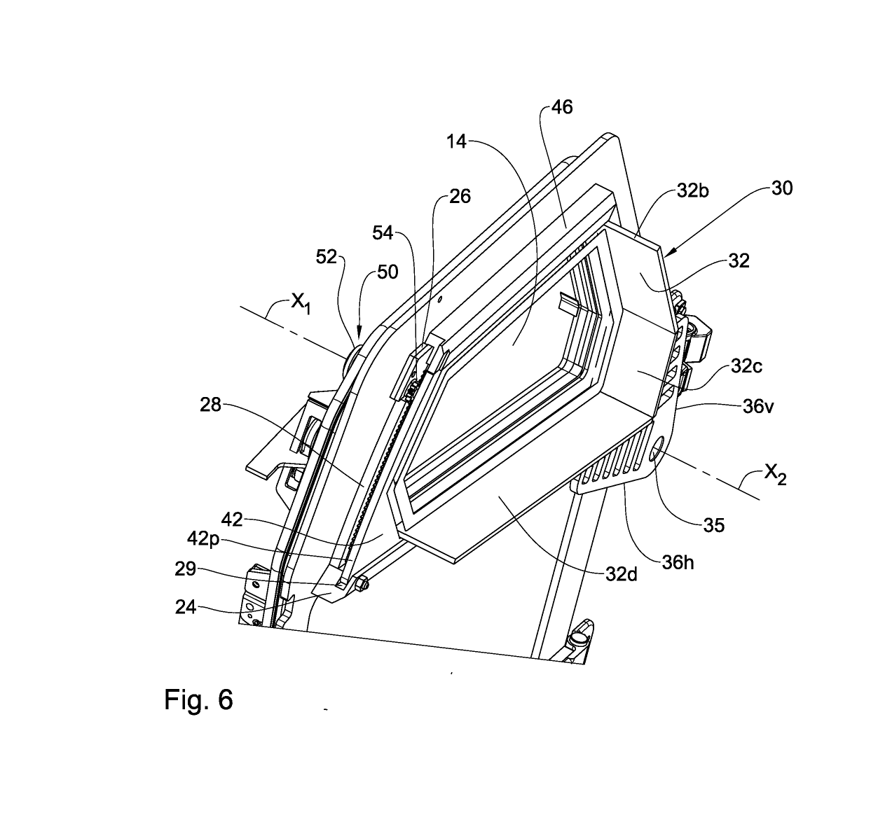

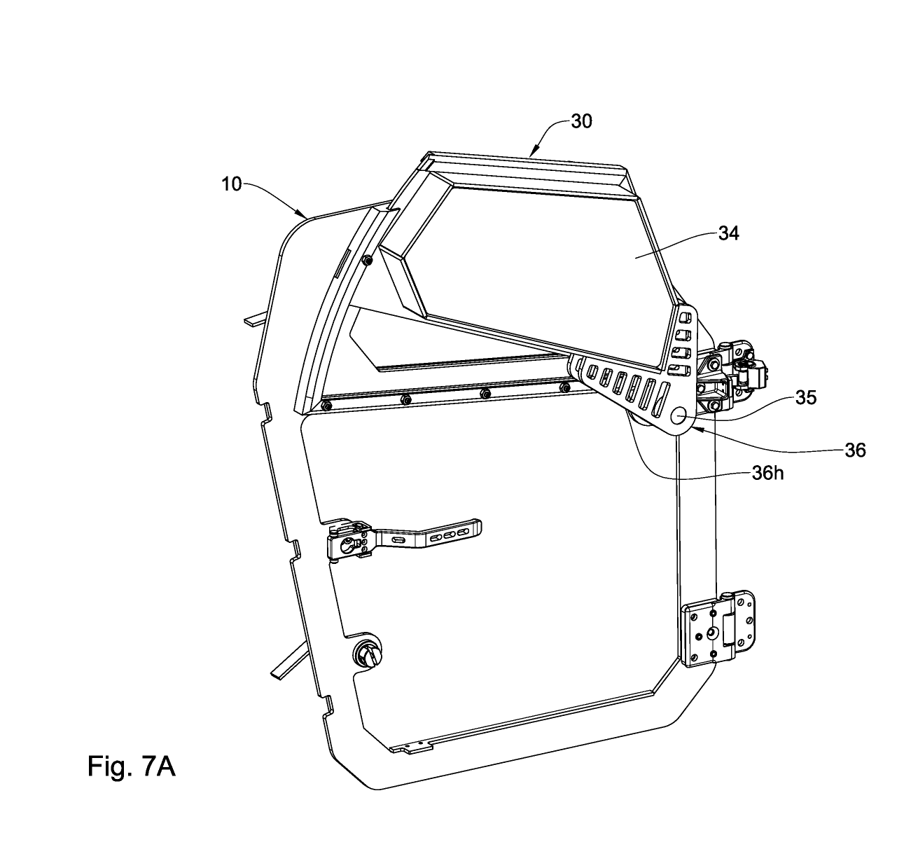

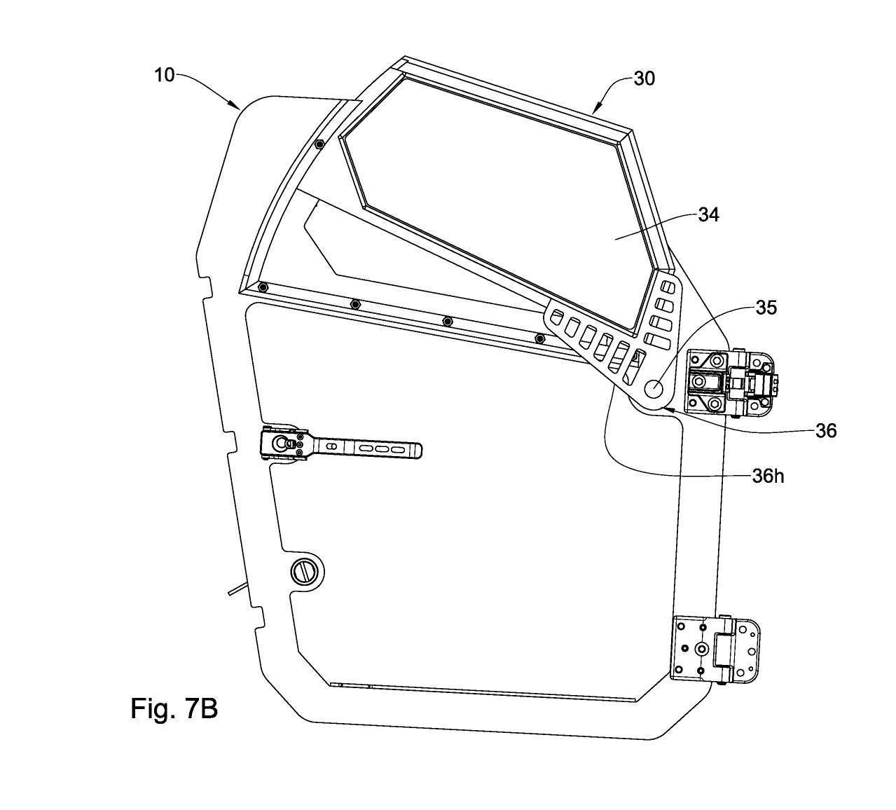

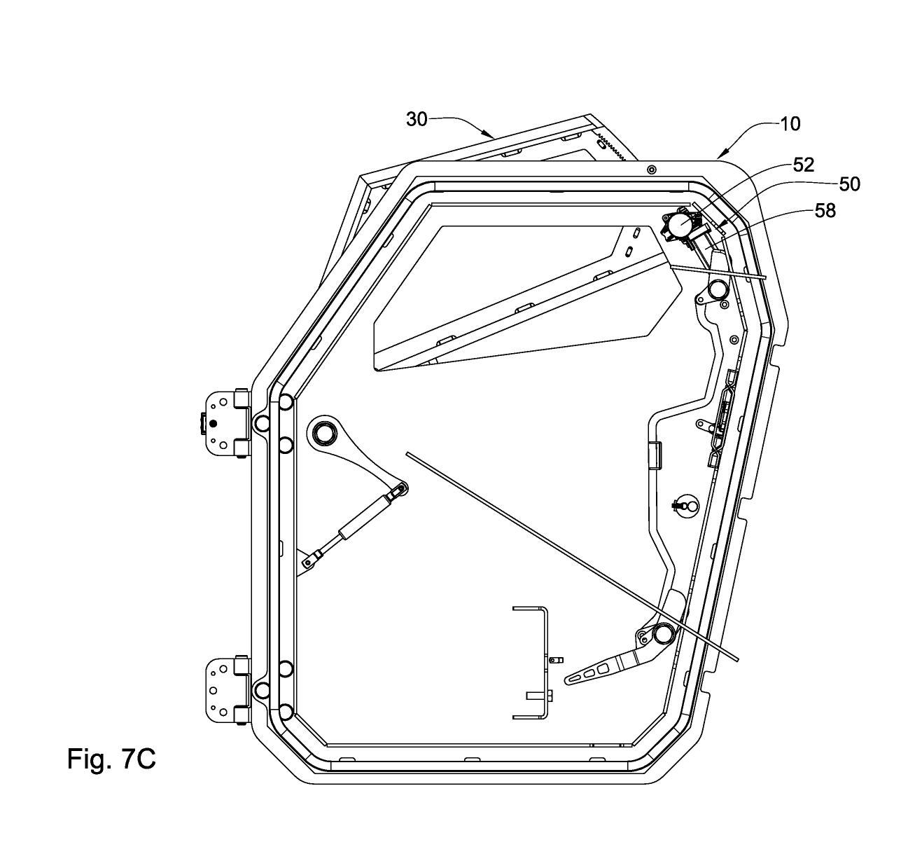

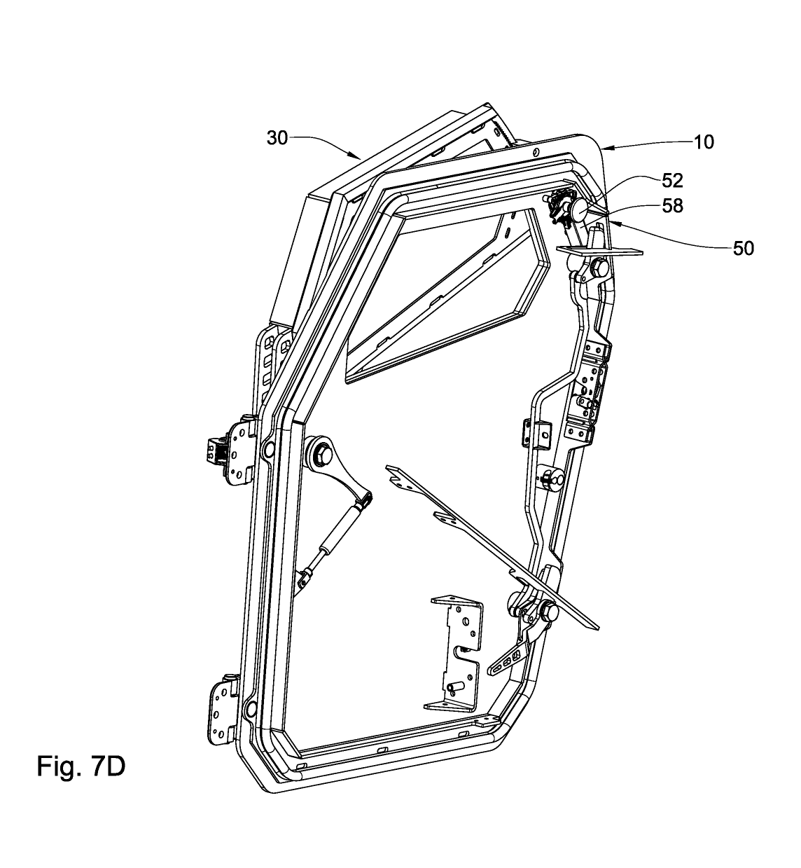

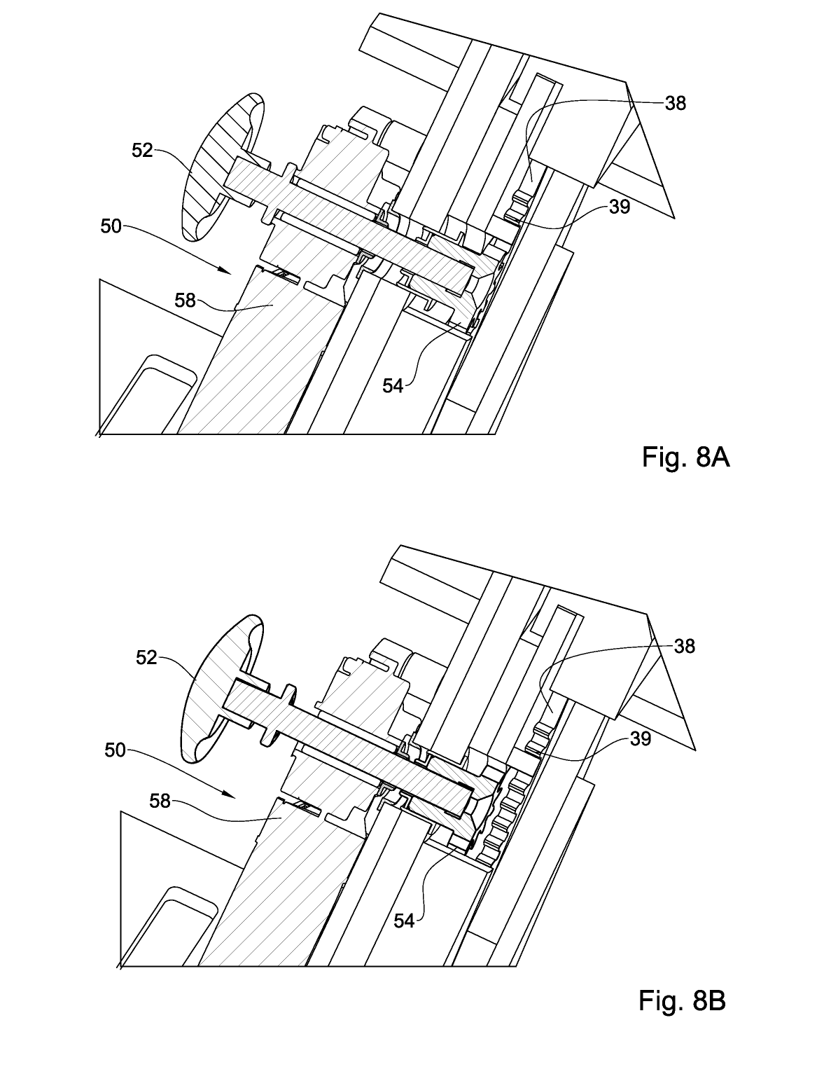

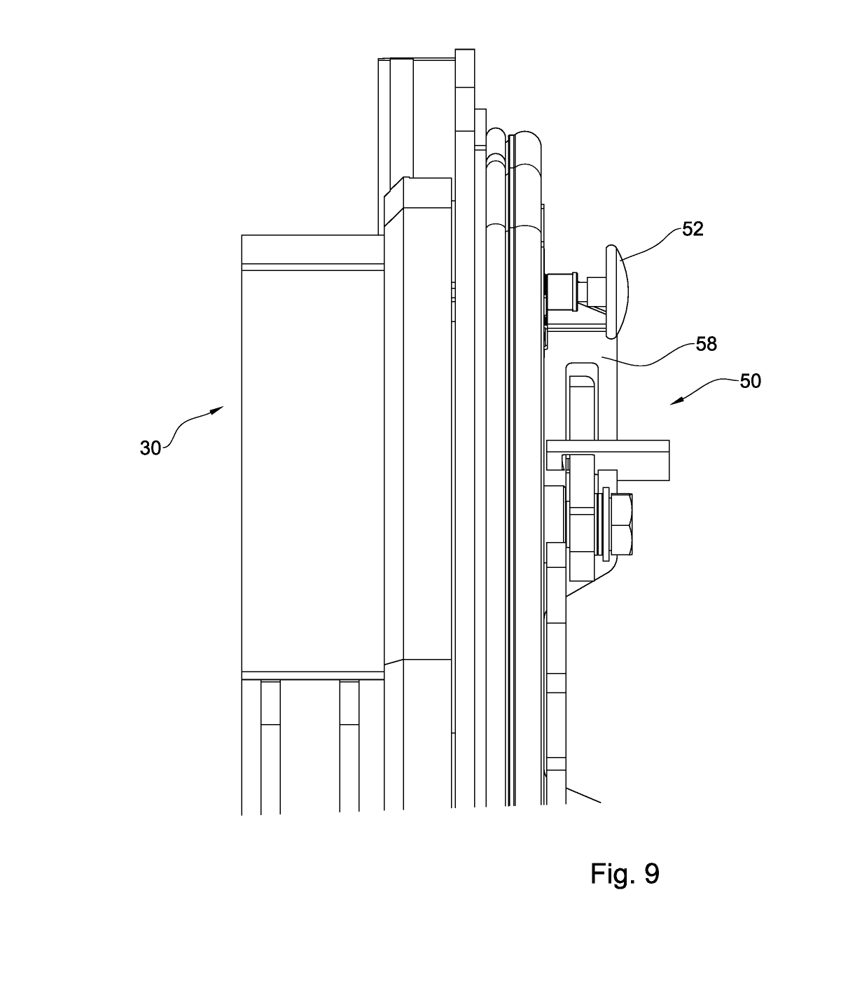

Attention is now drawn to FIGS. 3A and 3B, in which the window assembly 30 has been stripped of some of its components, so that it is observed the window assembly 30 further comprises a driven plate 38 fixedly attached to the window frame 32. The driven plate 38 extends beyond the irregular polygon of the frame 32, between the frame and the window. The driven plate 38 has a portion formed with a plurality of teeth 39. The portion of the driven plate 38 formed with the teeth 39 extends between an upper end 38u and a lower end 38l, along an arced trajectory, corresponding to the trajectory performed by the window assembly 30 when pivoting about the pivot hinge 35.

It is observed that the teeth 39 of the driven plate 38 are engaged with the teeth of the gear 54, so that rotation of the gear 54 about the axis of the shaft 56 entails rotational movement of the driven plate 38, and consequently of the entire window assembly 30 about the pivot hinge 35.

It is appreciated that the length of the portion of the driven plate 38 formed with the teeth 39 determines the movement range of the window, i.e. the offset between its closed position and its opened position.

It is also noted that the engagement between the gear 54 and driven plate 38 takes place at a location remote from the pivot hinge 35, so that the power required by the motor for pivoting the window about the hinge 35 is considerably smaller than the power that would be required if engagement took place closer to the pivoting hinge 35.

Further attention is now drawn to FIG. 3, in which the rear of the door 10 is shown fitted additionally with the counter-weight mechanism 60. The mechanism 60 comprises a housing 62 accommodating a piston 64, articulated to a lever arm 66, which is, in turn, attached to the pivot hinge 35.

The purpose of the counter-weight mechanism 60 is to provide to the hinge 35 a torque M2 which is equivalent and opposite in direction the torque M1 applied to the hinge 35 by the weight of the window assembly 30. In other words, the counter-weight mechanism 60 maintains the window assembly in equilibrium, so that pivoting the window assembly 30 about the pivot hinge 35 by a force other than that applied by the mechanism 40 does not require great power consumption.

The counter-weight mechanism 60 may be constituted by various pistons, e.g. hydraulic, pneumatic etc. and may even be constituted by an actual counter weight adapted to apply similar torque M2 to the hinge 35.

In operation of the drive motor 58, the shaft 56 and consequently the gear 54 begin revolving, and due to engagement with the driven plate 38, the entire window assembly 30 is configured to pivot about the hinge 35.

The window assembly 30 is configured for displacing between a first, fully closed position, as shown in FIGS. 1A to 1D, and a second, fully open position as shown in FIGS. 7A to 7D, in which the window frame 32 is oriented such that at least a portion of the opening 14 is exposed to the outside environment. Throughout the rotation/pivoting of the window assembly 30, the gear 54 remains engaged with the driven plate 38, so that the window assembly 30 may also assume a plurality of intermediate positions between the first and the second position.

It is appreciated that in displacing from the first, closed position to the second, open position, the window assembly 30 performs a generally upward movement, so that that portion of the opening 14 which is exposed is locates closer to a bottom part of the opening rather than to a top part thereof.

In the above operation, due to the operation of the counter-weight mechanism 60, the load applied by the drive motor 58 required to pivot the window assembly 30 about the pivot hinge 35 is essentially low, and so is the motor's 58 consumption for performing this operation.

It is also noted that throughout the entire operation of the driving mechanism 50, the motor 58 and gear 54 remain substantially in place, and only the window assembly 30 significantly displaces up and down.

Turning now to FIGS. 5A and 5B, and with reference to FIG. 1D, attention is drawn to the first and to the second protective arrangement 20, 40 mounted onto the door 10 and window assembly 30 respectively.

The second protective arrangement 40 is fitted to the window assembly 30 and is adapted to displace therewith during operation (pivoting). In particular, the second protective arrangement 40 comprises a protective plate 42 disposed between the window frame 32 and the driven member 38, which is sized and shaped to cover and shield the driven member 38 in a direction transverse to the outer surface 12o of the door 10.

The second protective arrangement 40 further comprises a protective plank 46 made of three segments 46a, 46b, 46c extending parallel and long the corresponding slats 32a, 32b, 32c of the window frame 32. Each of the segments 46a, 46b, 46c is formed with a slit 47, so that the cross-sectional shape thereof is L-shaped (FIG. 5A).

In addition, the segment 46a is formed with an end protrusion 49, having a width similar to that of the protective plate 42, and constituting a smooth extension thereof. The purpose of this extension 49 will be apparent from the following description of the first protective arrangement 20.

The first protective arrangement 20 comprises a first rail 22 and a second rail 24, the former extending along the pivoting trajectory of the window assembly 30. Each of the rails 22, 24 is formed with a central channel 23, 29 respectively, extending the entire length of the rail 22, 24.

The arrangement is such that in the first, closed position of the window assembly 30, a peripheral portion of the protective plate (i.e. the external rim thereof), is received within the channels 23, 29 of the rails 22, 24. Moreover, throughout the pivoting motion of the window assembly 30, there always remains a portion of the protective plate 42 received at least within the first rail 22.

In addition, it is observed that the design of the segment 46a is such that the extension 49 thereof is configured to be received, together with the portion of the protective plate 42 within the central channel 23 of the first rail 22.

Reverting to FIG. 2A, it is noted that the first protective arrangement further comprises a protective plank 26, formed of three segments 26a, 26b, 26c, extending generally parallel to the segments 46a, 46b, 46c. The segments 26a, 26b, 26c of the plank 26 are disposed such that a gap 27 is formed between the plank 26 and the outer surface 12o of the door 10.

It is observed from FIG. 5A that in the closed position shown, the protective plank 46 of the second protective arrangement 40 interlocks with the plank 26 of the first protective arrangement 20, thereby providing improved ballistic protection to the window 30 and door 10.

In addition, the first protective arrangement 20 comprises a plate 28, generally corresponding in shape and size to that of the driven member 38 and of the protective plate 42. The plate 28, together with the plank 26, form a protective frame around the opening 14 of the door 10.

It is also observed that both the plate 28 and the first rail 22 of the first protective arrangement 20 are formed with corresponding recesses 25a, 25b respectively, allowing the gear 54 of the drive mechanism 50 to extend towards the driven member 38 and to be engaged therewith.

In the initial position, the window assembly 30 is in its closed position as shown in FIG. 1A. In this position the window assembly 30 fully covers the opening 14 of the door 10 so that:
a bottom portion of the protective plate 42 is received within the second rail 24;
a side portion of the protective plate 42 is received within the first rail 22;
the segments 26a, 26b, 26c of the plank 26 are interlocked with the segments 46a, 46b, 46c of the plank 46; and
the gear 54 is engaged with the upper end 38u of the driven member 38.

In operation, the motor 58 of the drive mechanism 50 begins rotating the gear 54 in a counter-clockwise direction. Due to its engagement with the driven member 38, the gear 54 begins pushing up the driven member 38, thereby causing the entire window assembly 30 to pivot about the pivot hinge 35. It should be noted here that since the window assembly 30 is in equilibrium (i.e. upwardly biased by the counter-weight arrangement 60), there is required only little power from the motor 58 to pivot the window in an upward direction.

Upon pivoting, the bottom portion of the protective plate 42 is released from the second rail 24, and the side portion of the protective plate 42 is partially released from the first rail 22, such that only the corner of the protective plate 42 remains in engagement with the first rail 22. Simultaneously, the interlocking arrangement between the planks 26 and 46 is released, and the entire window assembly 30 pivots in a clockwise direction about the pivot hinge 35.

Pivoting may continue until the gear 54 reaches the lower end 38l of the driven member 38. It should also be understood that the window assembly 30 may be arrested in any intermediate position between these two ends, i.e. at a position where the gear 54 is located at an arbitrary point along the driven member 38 between the upper end 38u and the lower end 38l.

Pivoting of the window assembly 30 allows exposing a small portion of the opening 14 which is, on the one hand, large enough to stick a barrel of a firearm therethrough or exchange papers/document, and on the other hand, still provides protection for individuals located behind the inner surface 12i.

It should also be noted that throughout the operation of the window assembly 30, all components of the driving mechanism 50 as well as the driven member (or plate) 38 are protected by the planks, rails and plates of the first and second protective arrangement 20, 40.

Turning now to FIGS. 8A, 8B and 9, a selective decoupling mechanism 52 is shown, configured for selectively engaging and disengaging the driven plate 38 from the gear 54. In particular, when the decoupling mechanism 52 is pulled along the axis of the drive mechanism 50, the gear 54 is decoupled from the window, i.e. the teeth 39 of driven member 38 are disengaged from the teeth of the gear 54. The decoupling mechanism 52 can be manually pulled thus pulling the shaft 56 and disengaging the gear 54 from the teeth 39. This may be required, for example, if the drive motor 58 malfunctions or there is no power to power it, in which case pulling of the decoupling mechanism 52 unlocks the window assembly 30 from the drive mechanism 50 and enables freely manipulating the window assembly 30.

It is appreciated that one of the advantages provided by the decoupling mechanism 52 is the ability of manipulating the window in the event of malfunction of the driving mechanism of other mechanical failures. This may be of particular importance in emergency situations when the crew inside the vehicle is required to exit it. The decoupling mechanism 52 effectively switches the position of the window assembly 50 so that it is freely revolvable about the pivot hinge 35.

It is also appreciated that when the gear 54 is disengaged from the driven plate 38, the window assembly 30 can be opened to a much greater extent, and is essentially not limited in its ability to revolve about the pivot hinge 35. This is contrary to the position in which the hinge 54 and driven plate 38 are engaged, in which the movement range of the window assembly 30 is determined by the length of the portion formed with the teeth 39, i.e. the length between the upper end 38u and the lower end 38l.

Those skilled in the art to which this invention pertains will readily appreciate that numerous changes, variations, and modification can be made without departing from the scope of the invention, mutatis mutandis.

1. An assembly constituting a part of a structure having an interior, the assembly comprising:
a wall having an inner surface and an outer surface, wherein the wall is formed with an opening extending between the inner surface and the outer surface, and the opening has a rim area surrounding the opening;
a window comprising a frame sized and shaped so as to externally cover the opening and the rim area, and a window pane fitted within the frame, the window being attached to the outer surface of the wall in a displaceable manner;
a drive mechanism comprising a motor being located so as to be spaced from the outer surface of the wall by its inner surface, and a drive member connected to the motor and configured to be operated thereby, the drive member at least partially protruding from the outer surface of the wall in the direction away from its inner surface; and
a driven member attached to the window directly or indirectly, the driven member being disposed between the frame and the wall, and being configured for engagement with the drive member such as to displace the window and thereby expose exterior of the structure to its interior via at least a portion of the opening.

2. The assembly according to claim 1, wherein the window is displaceable, by virtue of the driving mechanism and driven member, between a first, fully closed position in which the frame of the window fully covers the opening and the rim area, and at least one additional position, which is a second, open position, in which the window is offset with respect to the opening, such that at least a portion of the opening is not covered by the window, allowing exposure of the environment to the interior of the structure.

3. The assembly according to claim 2, wherein the window is located, in its entirety, at the exterior of the structure, both in the first, closed and in the second, open position.

4. The assembly according to claim 2, wherein the window is displaceable between the first, fully closed position and an open, end position in which the window is at its maximal offset with respect to the opening, exposing a maximal portion of the opening to the exterior of the structure.

5. The assembly according to claim 2, wherein the window is configured such that when in the second, open position, the exposed portion of the opening is located at about the shoulder height of a person located within the structure and properly situated therein, so that the person is still able to maintain a direct line of vision to the exterior through the window, while at the same time having access to the portion of the opening.

6. The assembly according to claim 5, wherein the rim area has a top portion and a bottom portion, and wherein the arrangement is such that the window is configured, when in the second, open position, to expose a portion of the opening which is closer to the bottom portion of the rim area.

7. The assembly according to claim 1, wherein displacement of the window is achieved by a rotary movement, pivoting about an axis, and the window is articulated to the wall via a pivot hinge, so as to be displaceable thereabout under operation of the motor.

8. The assembly according to claim 7, wherein the driven member is attached and/or integrated with the window at a location thereof which is remote from the pivot hinge of the window.

9. The assembly according to claim 1, wherein the mechanical engagement between the driven member and the driving motor is selective, so that the window may assume a first, engaged position in which the driven member is engaged with the driving motor and is configured to be driven thereby and a second, disengaged position in which the driven member is disengaged from the driving motor.

10. The assembly according to claim 9, wherein selection between the engaged and disengaged position can be performed by a person located within the structure.

11. The assembly according to claim 9, wherein in the second, disengaged position, the window is configured to freely displace with respect to the opening of the structure.

12. The assembly according to claim 9, wherein in the second, disengaged position, the window has a greater movement range than in the first, engaged position.

13. The assembly according to claim 1, further comprising a load bearing device configured for providing the window with a counterweight force generally equivalent to a force generated by the weight of the window, so that under operation of the load bearing device, the window is generally at a mechanical equilibrium.

14. The assembly according to claim 13, wherein the load bearing device is configured for providing a moment about a pivot hinge which is equivalent and opposite in direction to the torque applied to the hinge by the weight of the window.

15. The assembly according to claim 13, wherein the load bearing device is configured for directly providing a load equivalent and opposite in direction to that of the weight of the window.

16. The assembly according to claim 1, wherein the wall is formed with at least one main protective rail within which a portion of the window is configured to be received and displace therealong, so that throughout the displacement of the window, a portion of the window is always received within the protective rail/s.

17. The assembly according to claim 16, wherein the wall further comprises at least one auxiliary protective rail configured for receiving another portion of the window.

18. The assembly according to claim 17, wherein the wall comprises a first auxiliary protective rail configured for receiving a first portion of the window, when the latter is in its first, fully closed position, and a second auxiliary protective rail configured for receiving therein a second portion of the window, when the latter is in its open, end position.

19. The assembly according to claim 1, wherein the assembly further comprises a protective plate disposed between the window frame and the driven member, and configured for providing at least the driven member with ballistic protection.

20. An armored vehicle comprising an assembly according to claim 1.
